(19) United States
(12) Patent Application Publication
(10) Pub. No.: US 2023/0231136 A1
(43) Pub. Date: Jul. 20, 2023

(54) ELECTRODE LAYER AND ALL-SOLID STATE BATTERY

(71) Applicants: TOYOTA JIDOSHA KABUSHIKI KAISHA, Toyota-shi (JP); Panasonic Holdings Corporation, Osaka (JP)

(72) Inventors: Akio MITSUI, Anjo-shi (JP); Yasunari SUGITA, Osaka-shi (JP); Yasutaka TSUTSUI, Osaka-shi (JP)

(73) Assignees: TOYOTA JIDOSHA KABUSHIKI KAISHA, Toyota-shi (JP); Panasonic Holdings Corporation, Osaka (JP)

(21) Appl. No.: 17/979,092

(22) Filed: Nov. 2, 2022

(30) Foreign Application Priority Data
Jan. 5, 2022 (JP) 2022-000470

(51) Int. Cl. H01M 4/62; H01M 10/0525; H01M 10/0585; H01M 10/0562

(52) U.S. Cl. CPC H01M 4/62; H01M 10/0525; H01M 10/0562; H01M 10/0585; H01M 2220/20; H01M 2300/0068

(57) ABSTRACT

An electrode layer for an all-solid state battery contains an electrode active material, a sulfide solid electrolyte, and a residual liquid, where the residual liquid has a δ_{P} of less than 2.9 MPa^{½} in a Hansen solubility parameter and a boiling point of 190° C. or higher.

### CROSS-REFERENCE TO RELATED APPLICATION

This application claims priority to Japanese Patent Application No. 2022-000470 filed on Jan. 5, 2022, incorporated herein by reference in its entirety.

### BACKGROUND

### 1. Technical Field

The present disclosure relates to an electrode layer and an all-solid state battery.

### 2. Description of Related Art

An all-solid state battery is a battery having a solid electrolyte layer between a positive electrode layer and a negative electrode layer, and it has an advantage that a safety device can be easily simplified as compared with a liquid-based battery having an electrolytic solution containing a flammable organic solvent. For example, WO 2019/203334 discloses a solid electrolyte composition containing an inorganic solid electrolyte, a binder, and a dispersion medium. Further, WO 2019/203334 discloses that the solubility parameter of the dispersion medium is 21 MPa^{½} or less. Further, Japanese Unexamined Patent Application Publication No. 2021-132010 (JP 2021-132010 A) discloses that butyl butyrate is used as a dispersion medium at the time of producing a positive electrode layer and a negative electrode layer.

### SUMMARY

From the viewpoint of improving the performance of an all-solid state battery, an electrode layer having a good capacity retention rate has been demanded. The present disclosure provides an electrode layer having a good capacity retention rate.

A first aspect of the present disclosure is an electrode layer for an all-solid state battery. The electrode layer contains an electrode active material, a sulfide solid electrolyte, and a residual liquid, where the residual liquid has a δ_{P} of less than 2.9 MPa^{½} in a Hansen solubility parameter and a boiling point of 190° C. or higher.

According to the first aspect of the present disclosure, since the δ_{P} and the boiling point of the residual liquid are in a predetermined range, the electrode layer has a good capacity retention rate.

In the first aspect of the present disclosure, the amount of the residual liquid in the electrode layer may be 1,500 ppm or more and 5,000 ppm or less.

In the first aspect of the present disclosure, the residual liquid may contain at least one of a naphthalene-based compound, a lauryl group-containing compound, and a monocyclic aromatic compound.

In the first aspect of the present disclosure, the residual liquid may contain the naphthalene-based compound.

In the first aspect of the present disclosure, the naphthalene-based compound may be tetralin.

In the first aspect of the present disclosure, the residual liquid may contain the lauryl group-containing compound.

In the first aspect of the present disclosure, the residual liquid may contain the monocyclic aromatic compound.

In the first aspect of the present disclosure, the electrode layer may be a positive electrode layer.

In the first aspect of the present disclosure, the electrode layer may be a negative electrode layer.

In addition, a second aspect of the present disclosure is an all-solid state battery having a positive electrode layer, a negative electrode layer, and a solid electrolyte layer arranged between the positive electrode layer and the negative electrode layer. In the all-solid state battery, at least one of the positive electrode layer and the negative electrode layer is the electrode layer described above.

According to the aspect of the present disclosure, since the above-described electrode layer is used, the all-solid state battery has a good capacity retention rate.

According to the aspect of the present disclosure, it is possible to obtain an effect that an electrode layer having a good capacity retention rate can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view exemplarily illustrating an all-solid state battery in the present disclosure.

### DETAILED DESCRIPTION OF EMBODIMENTS

Hereinafter, an electrode layer and an all-solid state battery in the present disclosure will be described in detail.

### A. Electrode Layer

An electrode layer in the present disclosure is an electrode layer that is used for an all-solid state battery, and the electrode layer contains an electrode active material, a sulfide solid electrolyte, and a residual liquid, where the residual liquid has a δ_{P} of less than 2.9 MPa^{½} in a Hansen solubility parameter and a boiling point of 190° C. or higher.

According to the present disclosure, since the δ_{P} and the boiling point of the residual liquid are in a predetermined range, the electrode layer has a good capacity retention rate. Here, the δ_{P} in the Hansen solubility parameter (HSP) corresponds to the dipole interaction energy between molecules. A residual liquid having a large δ_{P} easily dissolves a sulfide solid electrolyte, and thus the elution of elements constituting the sulfide solid electrolyte occurs easily. For example, WO 2019/203334 discloses various dispersion media, such as butyl butyrate, as specific examples of the dispersion medium having an SP value of 21 MPa^{½} or less. In a case where the electrode layer contains butyl butyrate as a residual liquid, it reacts with a sulfide solid electrolyte, which results in the deterioration of the sulfide solid electrolyte (the decrease in ion conductivity), since the δ_{P} of butyl butyrate is relatively large. As a result, the charging and discharging cycle characteristics deteriorate. On the other hand, in the present disclosure, since the electrode layer contains a residual liquid having a small δ_{P}, it is possible to suppress the reaction between the residual liquid and the sulfide solid electrolyte. As a result, the electrode layer has a good capacity retention rate.

Further, in a case where the electrode layer is produced using a dispersion medium having a low boiling point, the dispersion medium easily volatilizes from the electrode layer at the time of drying, whereas cracking easily occurs in the electrode layer. The reason therefor is conceived to be that a binder contained in the electrode layer segregates at the time of drying. On the other hand, in the present disclosure, since the boiling point of the residual liquid remaining in the electrode layer is high, it is possible to suppress the occurrence of cracking in the electrode layer. In particular, since the residual liquid contained in the electrode layer has a small δ_{P} and a high boiling point, the electrode layer has a good capacity retention rate even in a case where the amount of the residual liquid is drastically increased as described in Examples described later. Table 1 shows specific examples of the δ_{P} and the boiling point of the dispersion medium.

TABLE 1

| Residual liquid | δ_{P} (MPa^{½}) | Boling point ( °C) |
|---|---|---|
| Tetralin | 2.0 | 205 |
| Butyl butyrate | 2.9 | 165 |
| Diisobutyl ketone | 3.7 | 168.4 |
| Xylene | 1.0 | 138 to 144 |
| Toluene | 1.4 | 144 |

### 1. Residual Liquid

The electrode layer in the present disclosure contains a residual liquid. The residual liquid is a liquid component remaining in the electrode layer. The residual liquid is typically a dispersion medium in a paste described below. In addition, the residual liquid has a δ_{P} of less than 2.9 MPa^{½} in a Hansen solubility parameter and a boiling point of 190° C. or higher. The electrode layer may contain only one kind of such residual liquid or may contain two or more kinds of thereof.

δ_{P} in the residual liquid is generally less than 2.9 MPa^{½}. δ_{P} may be 2.5 MPa^{½} or less, may be 2.3 MPa^{½} or less, or may be 2.1 MPa^{½} or less. In a case where δ_{P} is large, there is a possibility that the deterioration of the sulfide electrolyte due to the residual liquid is not suppressed sufficiently.

The boiling point of the residual liquid is generally 190° C. or higher, and it may be 200° C. or higher, may be 205° C. or higher, or may be 210° C. or higher. In a case where the boiling point of the residual liquid is low, there is a possibility that the cracking of the electrode layer is not suppressed sufficiently. On the other hand, the boiling point of the residual liquid is, for example, 300° C. or lower, and it may be 250° C. or lower. In a case where the boiling point of the residual liquid is high, it is necessary, for example, to increase the drying temperature, in order to remove the residual liquid, and thus the production efficiency easily decreases.

Examples of the residual liquid include a naphthalene-based compound, a lauryl group-containing compound, and a monocyclic aromatic compound. The naphthalene-based compound is a compound having a naphthalene skeleton, and examples thereof include tetralin (tetrahydronaphthalene) and naphthalene. The residual liquid may be or may not be tetralin. The lauryl group-containing compound is a compound having a lauryl group (a dodecyl group), and examples thereof include N,N-dimethyllaurylamine (N,N-dimethyldodecylamine). The monocyclic aromatic compound is a compound having a monocyclic aromatic hydrocarbon (typically, a benzene ring). The monocyclic aromatic compound may have one monocyclic aromatic hydrocarbon, may have two monocyclic aromatic hydrocarbons, or may have three or more monocyclic aromatic hydrocarbons. Examples of the monocyclic aromatic compound include divinylbenzene, tetramethylbenzene (for example, 1,2,3,5-tetramethylbenzene and 1,2,3,4-tetramethylbenzene), and diphenylmethane.

The amount of the residual liquid in the electrode layer is, for example, 500 ppm or more and 7,000 ppm or less, and it may be 1,000 ppm or more and 6,000 ppm or less or may be 1,500 ppm or more and 5,000 ppm or less. In a case where the amount of the residual liquid is small, cracking easily occurs in the electrode layer. On the other hand, even in a case where the amount of the residual liquid is large, the effect on the capacity retention rate is small; however, the volumetric energy density may be reduced relatively. Further, in the present disclosure, even in a case where the amount of the residual liquid is relatively large, the capacity retention rate hardly decreases. As a result, there is an advantage that the drying step at the time of producing the electrode layer can be simplified. The amount of the residual liquid can be determined by gas chromatography mass spectrometry (GC-MS) as described later.

### 2. Electrode Active Material

The electrode layer in the present disclosure contains an electrode active material. The electrode active material may be a positive electrode active material or may be a negative electrode active material.

Examples of the positive electrode active material include an oxide active material. Examples of the oxide active material include rock salt layer-type active materials such as LiCoO₂, LiMnO₂, LiNiO₂, LiVO₂, and LiNi_{⅓}Co_{⅓}Mn_{⅓}O₂, spinel-type active material such as LiMn₂O₄, and Li(Ni_{0.5}Mn_{1.5})O₄, LiFePO₄, and olivine-type active substances such as LiMnPO₄, LiNiPO₄, and LiCoPO₄. The surface of the positive electrode active material is preferably coated with an ion conductive oxide. This is because it is possible to suppress the reaction between the positive electrode active material and the sulfide solid electrolyte to form a high resistance layer. Examples of the ion conductive oxide include LiNbO₃. The thickness of the ion conductive oxide is, for example, 1 nm or more and 30 nm or less.

Examples of the negative electrode active material include Li-based active materials such as metallic lithium and a lithium alloy; carbon-based active materials such as graphite and hard carbon; oxide-based active materials such as lithium titanate; and Si-based active materials such as an Si single body, an Si alloy, and silicon oxide (SiO). Lithium titanate (LTO) is a compound containing Li, Ti, and O. Examples of the composition of lithium titanate include LiₓTi_{y}O_{z} (3.5 ≤ x ≤ 4.5, 4.5 ≤ y ≤ 5.5, and 11 ≤ z ≤ 13). x may be 3.7 or more and 4.3 or less, or it may be 3.9 or more and 4.1 or less. y may be 4.7 or more and 5.3 or less, or it may be 4.9 or more and 5.1 or less. z may be 11.5 or more and 12.5 or less, or it may be 11.7 or more and 12.3 or less. Lithium titanate preferably has a composition represented by Li₄Ti₅O₁₂.

Examples of the shape of the electrode active material include a particle shape. The average particle diameter (D₅₀) of the electrode active material is, for example, 10 nm or more and 50 nm or less, and it may be 100 nm or more and 20 µm or less. The average particle diameter (D₅₀) represents a particle diameter (a median diameter) of 50% accumulation of the cumulative particle diameter distribution, and the average particle diameter is calculated from, for example, the measurement by a laser diffraction type particle diameter distribution meter or a scanning electron microscope (SEM).

The proportion of the electrode active material in the electrode layer is, for example, 20% by volume or more and 80% by volume or less, and it may be 30% by volume or more and 70% by volume or less, or may be 40% by volume or more and 65% by volume or less. In a case where the proportion of the electrode active material is small, there is a possibility that the volumetric energy density is not reduced sufficiently. On the other hand, in a case where the proportion of the electrode active material is large, there is a possibility that the ion conduction path is not formed sufficiently.

### 3. Sulfide Solid Electrolyte

The electrode layer in the present disclosure contains a sulfide solid electrolyte. The sulfide solid electrolyte constitutes an ion conduction path in the electrode layer. The sulfide solid electrolyte generally contains sulfur (S) as the main component of the anionic elements. The sulfide solid electrolyte contains, for example, Li, A (A is at least one of P, As, Sb, Si, Ge, Sn, B, Al, Ga, and In), and S. A preferably contains at least P, and the sulfide solid electrolyte may contain at least one of Cl, Br, and I as a halogen. Further, the sulfide solid electrolyte may contain O.

The sulfide solid electrolyte may be a glass-based sulfide solid electrolyte, may be a glass-ceramic-based sulfide solid electrolyte, or may be a crystalline sulfide solid electrolyte. In a case where the sulfide solid electrolyte has a crystal phase, examples the crystal phase thereof include a Thio-LISICON-type crystal phase, an LGPS-type crystal phase, and an argyrodite-type crystal phase.

The composition of the sulfide solid electrolyte is not particularly limited. However, examples thereof include xLi₂S·(100 - x)P₂S₅ (70 ≤ x ≤ 80) and yLiI·zLiBr·(100 - y - z)(xLi₂S·(1 - x)P₂S₅) (0.7 ≤ x ≤ 0.8, 0 ≤ y ≤ 30, 0 ≤ z ≤ 30).

The sulfide solid electrolyte may have a composition represented by the general formula: Li₄₋ₓGe₁₋ₓPₓS₄ (0 < x < 1). In the above general formula, at least a part of Ge may be substituted with at least one of Sb, Si, Sn, B, Al, Ga, In, Ti, Zr, V, and Nb. In the above general formula, at least a part of P may be substituted with at least one of Sb, Si, Sn, B, Al, Ga, In, Ti, Zr, V, and Nb. In the above general formula, a part of Li may be substituted with at least one of Na, K, Mg, Ca, and Zn. In the above general formula, a part of S may be substituted with a halogen (at least one of F, Cl, Br, and I).

Examples of other compositions of the sulfide solid electrolyte include Li_{7-x-2y}PS_{6-x-y}X_{y}, Li_{8-x-2y}SiS_{6-x-y}X_{y}, and Li_{8-x-2y}GeS_{6-x-y}X_{y}. In these compositions, X is at least one of F, Cl, Br, and I, and x and y respectively satisfy 0 ≤ x and 0 ≤ y.

The sulfide solid electrolyte preferably has high Li ion conductivity. The Li ion conductivity of the sulfide solid electrolyte at 25° C. is, for example, 1 × 10⁻⁴ S/cm or more, and it is preferably 1 ×10⁻³ S/cm or more. The sulfide solid electrolyte preferably has high insulating properties. The electron conductivity of the sulfide solid electrolyte at 25° C. is, for example, 10⁻⁶ S/cm or less, and it may be 10⁻⁸ S/cm or less or may be 10⁻¹⁰ S/cm or less. In addition, examples of the shape of the sulfide solid electrolyte include a particle shape. The average particle diameter (D₅₀) of the sulfide solid electrolyte is, for example, 0.1 µm or more and 50 µm or less.

The proportion of the sulfide solid electrolyte in the electrode layer is, for example, 15% by volume or more and 75% by volume or less, and it may be 15% by volume or more and 60% by volume or less. In a case where the proportion of sulfide solid electrolyte is low, there is a possibility that the ion conduction path is not formed sufficiently. On the other hand, in a case where the proportion of the sulfide solid electrolyte is high, there is a possibility that the volumetric energy density is reduced.

The proportion of the electrode active material to the total of the electrode active material and the sulfide solid electrolyte is, for example, 40% by volume or more and 80% by volume or less, and it may be 50% by volume or more and 80% by volume or less or may be 60% by volume or more and 70% by volume or less. In a case where the proportion of the electrode active material is small, there is a possibility that the volumetric energy density is not reduced sufficiently. On the other hand, in a case where the proportion of the electrode active material is large, there is a possibility that the ion conduction path is not formed sufficiently.

The proportion of the total of the electrode active material and the sulfide solid electrolyte in the electrode layer is, for example, 75% by volume or more and less than 100% by volume, and it may be 80% by volume or more and less than 100% by volume or may be 90% by volume or more and less than 100% by volume.

### 4. Electrode Layer

The electrode layer in the present disclosure contains the electrode active material, the sulfide solid electrolyte, and the residual liquid, which are described above. The electrode layer may be a positive electrode layer or may be a negative electrode layer.

The electrode layer in the present disclosure may contain a conductive material. Examples of the conductive material include a carbon material, a metal particle, and a conductive polymer. Examples of the carbon material include particle-shaped carbon materials such as acetylene black (AB) and Ketjen black (KB), and fiber-shaped carbon materials such as carbon fiber, carbon nanotube (CNT), and carbon nanofiber (CNF). The proportion of the conductive material in the electrode layer is, for example, 0.1% by volume or more and 10% by volume or less, and it may be 0.3% by volume or more and 10% by volume or less.

The electrode layer in the present disclosure may contain a binder. Examples of the binder include fluorine-based binders such as polyvinylidene fluoride (PVDF) and polytetrafluoroethylene (PTFE) and rubber-based binders such as acrylate-butadiene rubber (ABR) and styrene-butadiene rubber (SBR). The proportion of the binder in the electrode layer is, for example, 1% by volume or more and 20% by volume or less, and it may be 5% by volume or more and 20% by volume or less. The thickness of the electrode layer is, for example, 0.1 µm or more and 1000 µm or less.

A method of manufacturing the electrode layer in the present disclosure is not particularly limited. In the present disclosure, it is also possible to provide a method of manufacturing an electrode layer, which is a method of manufacturing an electrode layer for an all-solid state battery and includes a preparatory step of preparing a paste containing an electrode active material, a sulfide solid electrolyte, and a dispersion medium, a coating step of applying the paste to form a coating layer, and a drying step of drying the coating layer to remove the dispersion medium, in which the dispersion medium has a δ_{P} of less than 2.9 MPa^{½} in a Hansen solubility parameter and a boiling point of 190° C. or higher. The paste may further contain at least one of a conductive material and a binder. The method of applying the paste is not particularly limited, and examples thereof include a blade method. The drying temperature of the coating layer is, for example, 80° C. or higher and 120° C. or lower. The drying time of the coating layer is, for example, 10 minutes or more and 5 hours or less. The residual amount of the dispersion medium (the amount of the residual liquid) in the electrode layer is preferably in the above-described range.

### B. All-Solid State Battery

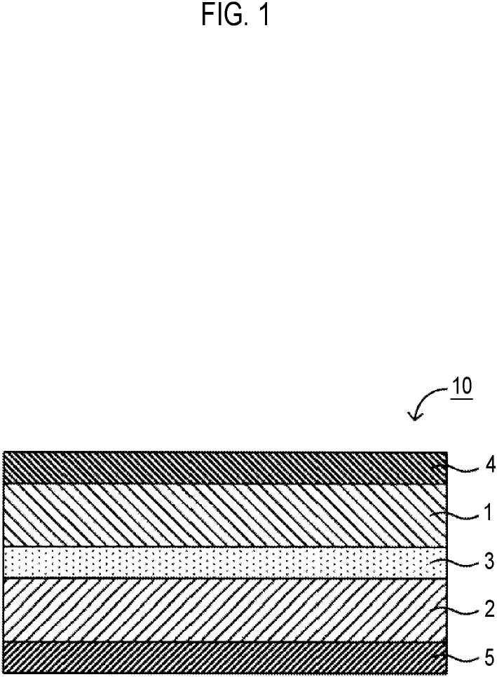

FIG. 1 is a schematic cross-sectional view exemplarily illustrating an all-solid state battery in the present disclosure. An all-solid state battery 10 illustrated in FIG. 1 has a positive electrode layer 1, a negative electrode layer 2, a solid electrolyte layer 3 arranged between the positive electrode layer 1 and the negative electrode layer 2, a positive electrode current collector 4 that collects current from the positive electrode layer 1, and a negative electrode current collector 5 that collects current from the negative electrode layer 2. In the present disclosure, at least one of the positive electrode layer 1 and the negative electrode layer 2 is the electrode layer described in “A. Electrode layer”.

According to the present disclosure, since the above-described electrode layer is used, the all-solid state battery has a good capacity retention rate.

### 1. Positive Electrode Layer and Negative Electrode Layer

Since the positive electrode layer and the negative electrode layer in the present disclosure are the same as those described in “A. Electrode layer” described above, the description thereof is omitted here. In the present disclosure, any one of the following cases may be good; (i) the positive electrode layer corresponds to the above-described electrode layer, but the negative electrode layer does not correspond to the above-described electrode layer, (ii) the positive electrode layer does not correspond to the above-described electrode layer, but the negative electrode layer corresponds to the above-described electrode layer, or (iii) both the positive electrode layer and the negative electrode layer correspond to the above-mentioned electrode layer.

### 2. Solid Electrolyte Layer

The solid electrolyte layer in the present disclosure is arranged between the positive electrode layer and the negative electrode layer. The solid electrolyte layer contains at least a solid electrolyte and may further contain a binder. Since the solid electrolyte and the binder are the same as those described in “A. Electrode layer” described above, the description thereof is omitted here. The thickness of the solid electrolyte layer is, for example, 0.1 µm or more and 1,000 µm or less.

### 3. All-Solid State Battery

In the present disclosure, the “all-solid state battery” refers to a battery equipped with a solid electrolyte layer (at least a layer containing a solid electrolyte). Further, the all-solid state battery in the present disclosure includes a power generation element that has a positive electrode layer, a solid electrolyte layer, and a negative electrode layer. The power generation element generally has a positive electrode current collector and a negative electrode current collector. The positive electrode current collector is arranged, for example, on the surface of the positive electrode layer on a side opposite to the solid electrolyte layer. Examples of the material of the positive electrode current collector include metals such as aluminum, SUS, and nickel. Examples of the shape of the positive electrode current collector include a foil shape and a mesh shape. On the other hand, the negative electrode current collector is arranged, for example, on the surface of the negative electrode layer on a side opposite to the solid electrolyte layer. Examples of the material of the negative electrode current collector include metals such as copper, SUS, and nickel. Examples of the shape of the negative electrode current collector include a foil shape and a mesh shape.

The all-solid state battery in the present disclosure may include an exterior body that houses the power generation element. Examples of the exterior body include a laminate-type exterior body and a case-type exterior body. Further, the all-solid state battery in the present disclosure may be equipped with a restraining jig that applies a restraining pressure in the thickness direction to the power generation element. A known jig can be used as the restraining jig. The restraining pressure is, for example, 0.1 MPa or more and 50 MPa or less, and it may be 1 MPa or more and 20 MPa or less. In a case where the restraining pressure is small, there is a possibility that a good ion conduction path and a good electron conduction path are not formed. On the other hand, in a case where the restraining pressure is large, there is a possibility that the size of the restraining jig becomes large and thus the volumetric energy density is reduced.

The kind of the all-solid state battery in the present disclosure is not particularly limited; however, it is typically a lithium ion secondary battery. The use application of the all-solid state battery is not particularly limited. However, examples thereof include a power source for a vehicle such as a hybrid electric vehicle (HEV), a plug-in hybrid electric vehicle (PHEV), a battery electric vehicle (BEV), a gasoline vehicle, or a diesel vehicle. In particular, it is preferably used as a power source for driving a hybrid electric vehicle, a plug-in hybrid electric vehicle, or a battery electric vehicle. Further, the all-solid state battery in the present disclosure may be used as a power source for a moving body (for example, a railway, a ship, or an aircraft) other than the vehicle or may be used as a power source for an electric product such as an information processing device.

It is noted that the present disclosure is not limited to the above embodiment. The above embodiment is an example, and thus any of those having substantially the same configuration and having the same action or effect as the technical idea described in the claims of the present disclosure is included in the technical scope of the present disclosure.

### Experimental Example 1

A sulfide solid electrolyte (10LiI·15LiBr·75 (0.75Li₂S·0.25P₂S₅)) was added to tetralin (δ_{P} = 2.0, boiling point: 205° C.), and the resultant mixture was mixed using an ultrasonic homogenizer (UH-50, manufactured by SMT Co., Ltd.) to obtain a dispersion liquid. Then, the solid content was separated by using a centrifuge to obtain a solution.

### Experimental Example 2

A solution was obtained in the same manner as in Experimental Example 1 except that butyl butyrate (δ_{P} = 2.9, boiling point: 165° C.) was used instead of tetralin.

### Evaluation

The Li amount in the solutions obtained in Experimental Examples 1 and 2 was determined by an acid decomposition/ICP emission spectroscopic analysis method (acid decomposition/ICP-AES). In addition, the S amount in the solutions obtained in Experimental Examples 1 and 2 was determined by an oxygen combustion/ion chromatography method. The results are shown in Table 2. The Li amount and the S amount, shown in Table 2, are relative values in a case where the result of Experimental Example 1 is set to 1.

TABLE 2

| | Dispersion medium | δ_{P} (MPa^{½}) | Li amount | S amount |
|---|---|---|---|---|
| Experimental Example 1 | Tetralin | 2.0 | 1 | 1 |
| Experimental Example 2 | Butyl butyrate | 2.9 | 180 | 48 |

As shown in Table 2, it was confirmed that tetralin has lower reactivity with the sulfide solid electrolyte due to having a small δ_{P} as compared with butyl butyrate.

### Example 1

A Li₄Ti₅O₁₂particle (LTO) was used as the negative electrode active material. The negative electrode active material, a conductive material (VGCF), a binder (PVdF), and a dispersion medium (tetralin, δ_{P} = 2.0, boiling point: 205° C.) were weighed and mixed for 30 minutes by using an ultrasonic homogenizer (UH-50, manufactured by SMT Co., Ltd.). Then, a sulfide solid electrolyte (LiI-LiBr-Li₂S-P₂S₅-based glass ceramic) was added and mixed again for 30 minutes by using an ultrasonic homogenizer (UH-50, manufactured by SMT Co., Ltd.). As a result, a negative electrode paste was obtained. Next, the negative electrode paste was applied onto a negative electrode current collector (an Ni foil). After coating, drying was carried out on a hot plate at 100° C. for 30 minutes. As a result, a negative electrode layer was formed on a negative electrode current collector.

### Comparative Example 1

A negative electrode layer was formed on a negative electrode current collector in the same manner as in Example 1 except that xylene (δ_{P} = 1.0, boiling point: 138° C.) was used instead of tetralin.

### Evaluation

The surface of the negative electrode layers produced in Example 1 and Comparative Example 1 was observed, and the occurrence of cracking was checked. The results are shown in Table 3.

TABLE 3

| | Dispersion medium | Boling point ( °C) | Cracking of negative electrode layer |
|---|---|---|---|
| Example 1 | Tetralin | 205 | Absent |
| Comparative Example 1 | xylene | 138 | Present |

As shown in Table 3, in Example 1, cracking did not occur in the negative electrode layer, whereas in Comparative Example 1, cracking occurred in the negative electrode layer. The reason therefor is presumed to be because xylene has a low boiling point and thus a large amount of thereof has volatilized in a short time at the time of drying. On the other hand, it is presumed to be because tetralin has a high boiling point and thus a large amount of thereof has not volatilized in a short time at the time of drying.

### Example 2

### Preparation of Positive Electrode Paste

As the positive electrode active material, LiNi_{⅓}Co_{⅓}Mn_{⅓}O₂ subjected to a surface treatment with LiNbO₃ was used. The positive electrode active material, a conductive material (VGCF), a sulfide solid electrolyte (LiI-LiBr-Li₂S-P₂S₅-based glass ceramic), a binder (PVdF), and a dispersion medium (tetralin, δ_{P} = 2.0, boiling point: 205° C.) were mixed by using an ultrasonic homogenizer (UH-50, manufactured by SMT Co., Ltd.). As a result, a positive electrode paste was obtained.

### Preparation of Negative Electrode Paste

A Li₄Ti₅O₁₂particle (LTO) was used as the negative electrode active material. The negative electrode active material, a conductive material (VGCF), a binder (PVdF), and a dispersion medium (tetralin, δ_{P} = 2.0, boiling point: 205° C.) were weighed and mixed for 30 minutes by using an ultrasonic homogenizer (UH-50, manufactured by SMT Co., Ltd.). Then, a sulfide solid electrolyte (LiI-LiBr-Li₂S-P₂S₅-based glass ceramic) was added and mixed again for 30 minutes by using an ultrasonic homogenizer (UH-50, manufactured by SMT Co., Ltd.). As a result, a negative electrode paste was obtained.

### Preparation of SE Layer Paste

A dispersion medium (heptane), a binder (a heptane solution containing 5% by mass of a butadiene rubber-based binder), and a sulfide solid electrolyte (LiI-LiBr-Li₂S-P₂S₅-based glass ceramic, average particle diameter D₅₀: 2.5 µm) were added in a polypropylene container and mixed for 30 seconds by using an ultrasonic homogenizer (UH-50, manufactured by SMT Co., Ltd.). Next, the container was shaken with a shaker for 3 minutes. As a result, a paste for a solid electrolyte layer (a paste for an SE layer) was obtained.

### Production of All-Solid State Battery

First, the positive electrode paste was applied onto a positive electrode current collector (an aluminum foil) by a blade method using an applicator. After coating, drying was carried out on a hot plate at 50° C. for 10 minutes, and then drying was further carried out on a hot plate at 100° C. for 10 minutes. As a result, a positive electrode having a positive electrode current collector and a positive electrode layer were obtained. Next, the negative electrode paste was applied onto a negative electrode current collector (an Ni foil). After coating, drying was carried out on a hot plate at 50° C. for 10 minutes, and then drying was further carried out on a hot plate at 100° C. for 10 minutes. As a result, a negative electrode having a negative electrode current collector and a negative electrode layer were obtained. Here, the weight per unit area of the negative electrode layer was adjusted so that the specific charging capacity of the negative electrode was 1.15 times in a case where the specific charging capacity of the positive electrode is set to 185 mAh/g.

Next, the positive electrode was pressed. The surface of the positive electrode layer after pressing was coated with the SE layer paste using a die coater and dried on a hot plate at 100° C. for 30 minutes. Then, roll pressing was carried out at a linear pressure of 5 tons/cm. As a result, a positive electrode side laminate having a positive electrode current collector, a positive electrode layer, and a solid electrolyte layer was obtained. Next, the negative electrode was pressed. The surface of the negative electrode layer after pressing was coated with the SE layer paste using a die coater and dried on a hot plate at 100° C. for 30 minutes. Then, roll pressing was carried out at a linear pressure of 5 tons/cm. As a result, a negative electrode side laminate including a negative electrode current collector, a negative electrode layer, and a solid electrolyte layer was obtained.

The positive electrode side laminate and the negative electrode side laminate were each subjected to punch processing and arranged so that the solid electrolyte layers faced each other, and an unpressed solid electrolyte layer was arranged between them. Then, roll pressing was carried out at 130° C. with a linear pressure of 2 tons/cm to obtain a power generation element having a positive electrode, a solid electrolyte layer, and a negative electrode in this order. The obtained power generation element was laminated and enclosed and then restrained at 5 MPa to obtain an all-solid state battery.

### Example 3

An all-solid state battery was produced in the same manner as in Example 2 except that the drying conditions at the time of producing each of the positive electrode layer and the negative electrode layer were changed to the conditions of carrying out drying on a hot plate at 80° C. for 10 minutes and then carrying out drying on a hot plate at 110° C. for 10 minutes.

### Comparative Example 2

A positive electrode paste and a negative electrode paste were prepared in the same manner as in Example 2 except that butyl butyrate (δ_{P} = 2.9, boiling point: 165° C.) was used as the dispersion medium, instead of tetralin. An all-solid state battery was produced in the same manner as in Example 2 except that each of the prepared pastes was used and the drying conditions at the time of producing each of the positive electrode layer and the negative electrode layer were changed to the conditions of carrying out drying on a hot plate at 100° C. for 30 minutes.

### Comparative Example 3

An all-solid state battery was produced in the same manner as in Comparative Example 2 except that the drying conditions at the time of producing each of the positive electrode layer and the negative electrode layer were changed to the conditions of carrying out drying on a hot plate at 100° C. for 15 minutes.

### Comparative Example 4

An all-solid state battery was produced in the same manner as in Comparative Example 2 except that the drying conditions at the time of producing each of the positive electrode layer and the negative electrode layer were changed to the conditions of carrying out drying on a hot plate at 95° C. for 30 minutes.

### Comparative Example 5

An all-solid state battery was produced in the same manner as in Comparative Example 2 except that the drying conditions at the time of producing each of the positive electrode layer and the negative electrode layer were changed to the conditions of carrying out drying on a hot plate at 90° C. for 30 minutes.

### Evaluation

### Measurement of Amount of Residual Liquid

The active material layers (the positive electrode layer and the negative electrode layer) were taken out from the electrodes (the positive electrode and the negative electrode) produced in Examples 2 and 3 and Comparative Examples 2 to 5 and stirred with methanol. Then, the solid content was separated by using a centrifuge to obtain a solution. The amount of the residual liquid (the amount of the residual dispersion medium) of the obtained solution was determined by gas chromatography mass spectrometry (GC-MS). The results are shown in Table 4.

### Measurement of Capacity Retention Rate

The capacity retention rate of the all-solid state batteries produced in Examples 2 and 3 and Comparative Examples 2 to 5 was measured. Specifically, each all-solid state battery was charged at a constant current mode with a current equivalent to 0.3 C, charged at a constant voltage mode after the cell voltage reached 2.7 V, and then the charging was terminated at the time when the charging current reached a value equivalent to 0.01 C. Then, it was discharged at a constant current mode with a current equivalent to 0.3 C, and the discharging was terminated at the time when the voltage reached 1.5 V. The discharge capacity was defined as the discharge capacity of the first cycle. Then, 5 cycles of charging and discharging were carried out under the same conditions, and the discharge capacity after the fifth cycle was determined. The capacity retention rate was determined by dividing the discharge capacity after the fifth cycle by the discharge capacity after the first cycle. The results are shown in Table 4.

TABLE 4

| | | Amount of residual liquid (ppm) | | Capacity retention rate (%) |
|---|---|---|---|---|
| | | Positive electrode | Negative electrode | |
| Example 2 | Tetralin | 2600 | 3100 | 98 |
| Example 3 | Tetralin | 1560 | 1320 | 99 |
| Comparative Example 2 | Butyl butyrate | 803 | 856 | 89 |
| Comparative Example 3 | Butyl butyrate | 2434 | 968 | 65 |
| Comparative Example 4 | Butyl butyrate | 1941 | 910 | 53 |
| Comparative Example 5 | Butyl butyrate | 1951 | 1350 | 51 |

As shown in Table 4, it was confirmed that the all-solid state batteries produced in Examples 2 and 3 have a high capacity retention rate as compared with the all-solid state batteries produced in Comparative Examples 2 to 5. Further, it was confirmed that in Comparative Examples 2 to 5, the capacity retention rate decreases as the amount of the residual liquid increases. On the other hand, it was confirmed that in Example 2, although an electrode layer having an amount of the residual liquid larger than that in Comparative Example 5 is used, a high capacity retention rate of 98% is obtained.

What is claimed is:

1. An electrode layer for an all-solid state battery, the electrode layer comprising:
an electrode active material;
a sulfide solid electrolyte; and
a residual liquid,
wherein the residual liquid has a δ_{P} of less than 2.9 MPa^{½} in a Hansen solubility parameter and a boiling point of 190° C. or higher.

2. The electrode layer according to claim 1, wherein an amount of the residual liquid in the electrode layer is 1,500 ppm or more and 5,000 ppm or less.

3. The electrode layer according to claim 1, wherein the residual liquid contains at least one of a naphthalene-based compound, a lauryl group-containing compound, and a monocyclic aromatic compound.

4. The electrode layer according to claim 3, wherein the residual liquid contains the naphthalene-based compound.

5. The electrode layer according to claim 4, wherein the naphthalene-based compound is tetralin.

6. The electrode layer according to claim 3, wherein the residual liquid contains the lauryl group-containing compound.

7. The electrode layer according to claim 3, wherein the residual liquid contains the monocyclic aromatic compound.

8. The electrode layer according to claim 1, wherein the electrode layer is a positive electrode layer.

9. The electrode layer according to claim 1, wherein the electrode layer is a negative electrode layer.

10. An all-solid state battery comprising:
a positive electrode layer;
a negative electrode layer; and
a solid electrolyte layer arranged between the positive electrode layer and the negative electrode layer,
wherein at least one of the positive electrode layer and the negative electrode layer is the electrode layer according to claim 1.
